(19) United States
(12) Patent Application Publication
(10) Pub. No.: US 2015/0339610 A1
(43) Pub. Date: Nov. 26, 2015

(54) METHOD OF EVALUATING A COMBINATION OF PROJECTS FOR INVESTMENT

(71) Applicant: Nicholi Hibbert, Oakland, NJ (US)

(72) Inventor: Nicholi Hibbert, Oakland, NJ (US)

(21) Appl. No.: 14/283,892

(22) Filed: May 21, 2014

(51) Int. Cl. G06Q 10/06

(52) U.S. Cl. CPC G06Q 10/06313

(57) ABSTRACT

A method of selecting, assembling, and displaying a combination of projects for a user includes selecting a first project from a collection. The method further includes adding the first project to the combination if the first project is within a user time-frame and the first project cost is less than a user budget. The method further includes subtracting the first project cost from the user budget via software executing on a computer. The method further includes selecting a second project from the collection. The method further includes adding the second project to the combination if the second project is within a user time-frame and the second project cost is less than a user budget via software executing on a computer. The method further includes displaying information about the combination to the user via software executing on a computer.

### TECHNICAL FIELD

The method described herein relates to investment decision making and, more particularly, to a method of assisting a user to evaluate a combination of projects for investment.

### BACKGROUND

With the scarcity of monetary funds and human capital, companies are searching for better ways to allocate their resources to get the greatest return on their project investments. Usually, business will have several potential projects that they can pursue, but limited resources. As a result, they cannot engage in all potential projects and need to carefully select which projects to undertake, when to undertake them, and which resources to allocate to them.

Currently available tools only focus on project management and do not provide a full level of support for project investment decisions. In other words, a user is not given a full range of information in a useful format that can assist them in making the best use of available resources.

As can be seen, there is a need for a method of evaluating a combination of projects for investment and providing investment recommendations that better enables a user to factor in all relevant information quickly and easily.

### BRIEF SUMMARY

A method of selecting, assembling, and displaying a combination of projects for a user includes selecting a first project from a collection. The method further includes adding the first project to the combination if the first project is within a user time-frame and the first project cost is less than a user budget. The method further includes subtracting the first project cost from the user budget via software executing on a computer. The method further includes selecting a second project from the collection. The method further includes adding the second project to the combination if the second project is within a user time-frame and the second project cost is less than a user budget via software executing on a computer. The method further includes displaying information about the combination to the user via software executing on a computer.

In some embodiments, the costs of the projects include man-hours required to complete the projects and the user budget includes available man-hours. In some embodiments, the method further includes subtracting the man-hours required for the first project from the available man-hours if the first and second projects temporally overlap via software executing on a computer, and adding the second project to the combination via software executing on a computer only if the man-hours required for the second project is less than the available man-hours. In some embodiments, the available man-hours includes a number of full-time and part-time employees available to the user and the required man-hours includes a number of full-time and part-time employees required for the projects; and the method includes determining if the required full-time and part-time employees is less than the available full-time and part-time employees. In some embodiments, the method further includes subtracting the full-time employees and part-time employees required for the first project from the available full-time and part-time employees via software executing on a computer if the first and second projects temporally overlap, and adding the second project to the combination via software executing on a computer only if the full-time and part-time employees required for the second project is less than the available full-time and part-time employees. In some embodiments, the project costs include the capital required for the projects, and the user budget includes available capital of the user.

In some embodiments, the method further includes assigning risk scores to projects in the collection, only adding the first project to the combination via software executing on a computer if the first project risk score is less than a user risk tolerance, only adding the second project to the combination via software executing on a computer if the second project risk score is less than a user risk tolerance. In some embodiments, the method further includes determining a cumulative risk score for the combination based on the risk scores of the first and second projects via software executing on a computer, and displaying the cumulative risk score to the user. In some embodiments, the risk scores are determined based on the locations and industries of the projects.

In some embodiments, the method further includes repeating the method to assemble a second combination of projects, and displaying information about the second combination to the user via software executing on a computer. In some embodiments, the method further includes comparing the combinations of projects via software executing on a computer, and displaying information generated from the comparison to a user via software executing on a computer.

### BRIEF DESCRIPTION OF THE DRAWINGS

FIG. 1 is a flow chart describing a method according to one embodiment.

FIG. 2 is a continuation of the flow chart of FIG. 1.

FIG. 3 is a continuation of the flow chart of FIG. 1.

FIG. 4 is a continuation of the flow chart of FIG. 1.

FIG. 5 is a continuation of the flow chart of FIG. 1.

FIG. 6 is a screenshot showing a project settings form in software executing a method according to the embodiment shown in FIG. 1.

FIG. 7 is a screenshot showing a project load form for entering a project into software executing a method according to the embodiment shown in FIG. 1.

FIG. 8 shows a screenshot of information about combinations generated by software executing a method according to the embodiment shown in FIG. 1.

### DETAILED DESCRIPTION

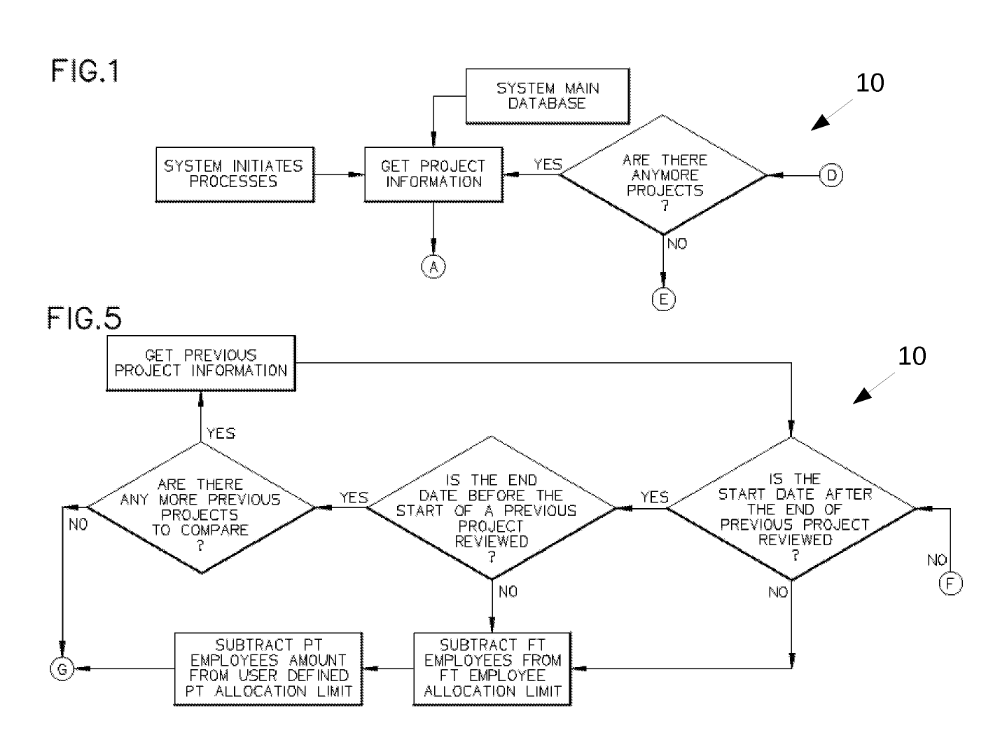

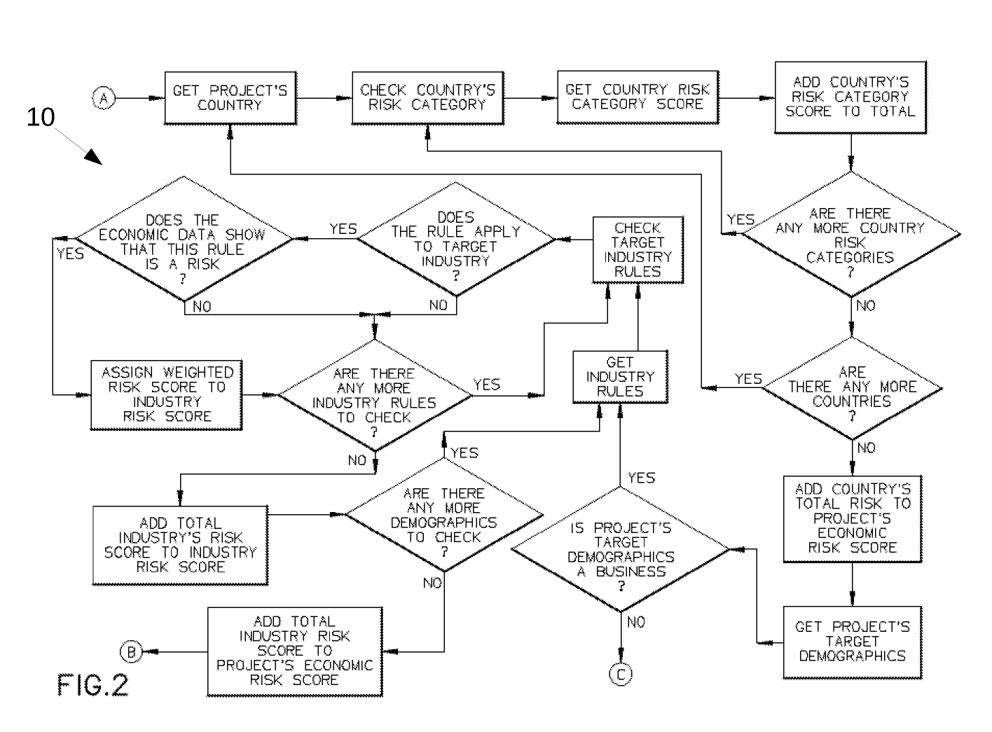

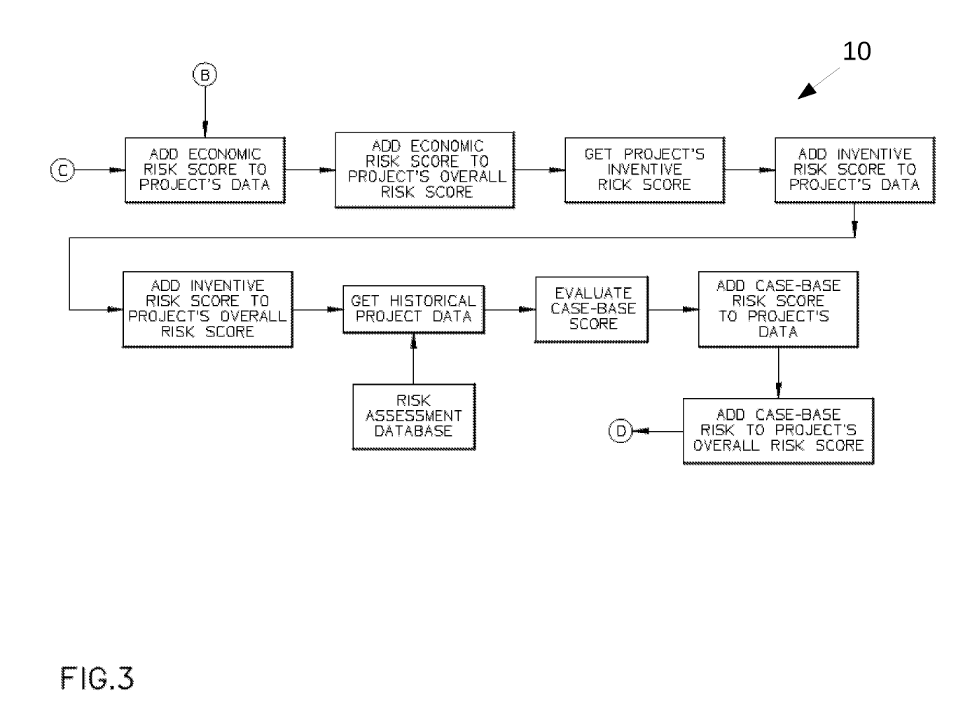

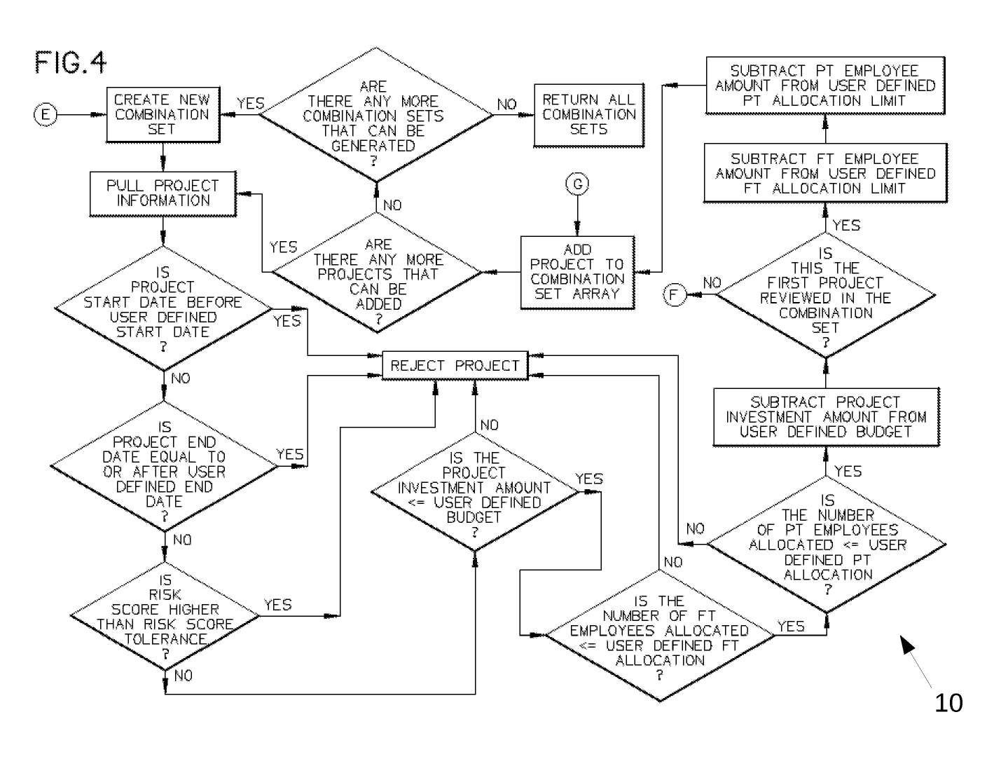

FIGS. 1-5 are a flow chart describing one embodiment of a method 10 of selecting, assembling, and displaying a combination of projects for a user. This method provides assistance in the decision making process in terms of investing in projects by generating combinations of projects based on the user's defined criteria. These combinations are generated in a matter of seconds with a recommended combination set. In addition, users are provided with alternate recommendations as well as financial, qualitative and economic reasoning behind project selections, thereby increasing the effectiveness of project investment decisions. The methods described herein can be used in sync with other project management software applications to provide more effective decision making.

A system main database can maintain the user's settings and project information. A risk database can hold economic information and information on past project cases. Software executing method 10 uses the system main database to get the main project information that will be used to generate a risk score by using the risk database before generating combinations. Once a risk score is established for each project, the software uses the user's settings from the system's main database and the cumulative risk score to filter out potential project combination sets. The software then filters the combinations sets even further into a best of three combination set and outputs financial, qualitative and economic charts for each combination set.

The system checks the user's program settings; if they haven't been set the system then prompts the user to enter his/her system settings. If the user has set his/her settings the system will allow the user to use the system's unlocked path.

As described above, once a user sets his/her settings and inputs the project information, the information is sent to the system's main database. The system's main database maintains information on the user's settings and project information and is used to make sure that the project combination sets are generated within the user's defined constraints.

After the user has completed inputting at least four projects he/she can then choose to save the project(s)'s information for later use. If he/she chooses to save the project's information it will be placed into the system database.

Once the generation button is pressed the system gets the users settings which include risk tolerance level, ROI rate, budget, net present value, the number of full-time and part-time employee to be allocated, combination set start and end date range, and whether qualitative factors are more important than financial factors (return on investment and other quantitative factors).

An added constraint that is used along with the user's system settings is a cumulative risk score. The risk database helps the system to generate a cumulative risk score for each project inputted into the system by the user by storing economic information and information on past project cases. The cumulative risk score is generated for each project according to method 10 when the user presses the button to generate the combination sets. The system pulls information from the risk assessment database and calculates a cumulative risk score for each project based on the type of project, the targeted industry, target geographic and demographic, its use or purpose, its level of inventiveness, and the success rate of past project cases that are similar to the project being assessed a risk score. The user's system settings and the cumulative risk score are used in the generate combinations and the process can reject projects that are either higher than the user's defined risk tolerance or are not within the user's system settings parameters.

The system checks if the project start date is before a user defined start date, if the project start date is equal to or after the user defined end date, and if the project's risk score is higher than the users risk tolerance. If any of the aforementioned if statements evaluate to true or yes, the project is rejected and the next project or combination set is reviewed/generated. If the if statements evaluate to false or no, then the next if-then statements are evaluated. These statements include the following questions: is the project investment amount less than or equal to the users defined budget, is the number of FT employees allocated less than or equal to the users defined FT allocation limit, and is the number of PT employees allocated less than or equal to the user's defined PT allocation limit will be checked. If any of these questions evaluate to false or no, then the project is rejected and the next project reviewed or combination set is generated. If they are all true or yes, then the project investment amount is subtracted from the user defined budget and then the next if-then statement is checked. If this isn't the first project reviewed in the combination set, then two more if statements are checked before further actions are performed. These next if-then statements are whether the start date of the current project is after the end date of a previous project reviewed for this combination set and whether the end date of the current project is before the start date of a previous project reviewed for this combination set. If one evaluates to false or no, then the FT and PT employees allocation are subtracted from the user defined limits. If they both evaluate to true or yes, then the next if statement is checked. Then, the next if statement checks if there are any more previous projects to compare to the current project if it evaluates to true then it will go through the if statements again.

The combination generation process according to the method can calculate the qualitative and risk scores for each project, generate the combination sets, and display financial, economic and qualitative charts for the user to examine so that he/she can make a decision about what project investments they should make. After the combination sets are produced and the three best combination sets are filtered out the system will display graphical results and details of all generated combination sets.

The user can then switch perspectives; which allows them to view additional financial, economic, and qualitative charts and diagrams based on their generated combination sets. The user can then choose to print or save the generated results for future viewing.

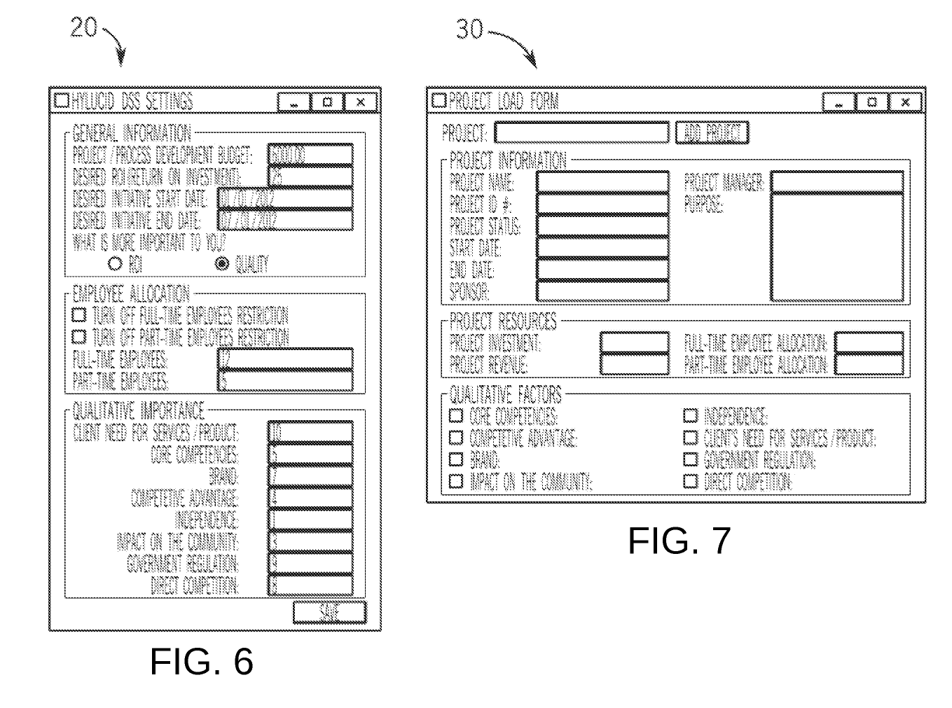

The method 10 described herein can be implemented by software executing on a computer. In the embodiments shown, the software accesses system main database and a risk assessment database to obtain information. The software can also use a display, graphical user interface, and user input to interface with a user. FIGS. 6-8 show screenshots of one embodiment of software executing on a computer that is implementing the method 10 described herein. These are examples of how software executing the method on a computer would use a graphical user interface to display and obtain information from a user.

FIG. 6 is a screen shot showing a project settings form 20 for a in software executing a method according to one embodiment. Project settings form 20 allows a user to enter in criteria for filtering the projects for adding to the combinations. FIG. 7 is a screen shot showing a project load 30 form for entering a project into software executing a method according to one embodiment. As can be seen, the user can input information about a project including cost an time-frame information, employee allocation, importance, and risk factors.

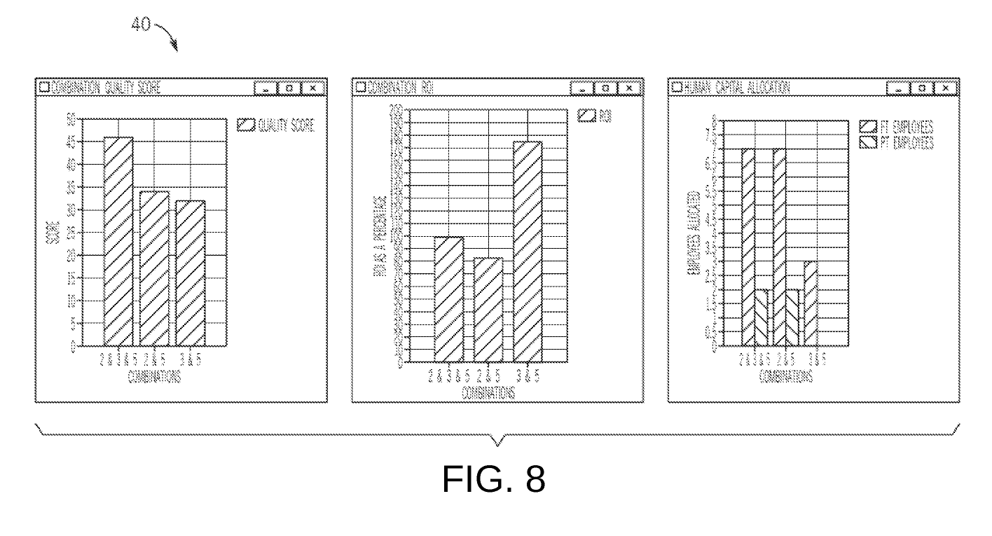

FIG. 8 shows a screen shot of output 40 generated by software executing a method according to one embodiment. As can be seen, the user can see a graphical comparison of several project combinations evaluated based on a scoring system, return on investment, and employee allocation. As can also be seen, the combinations can include more than two projects.

Although the invention has been described with reference to embodiments herein, those embodiments do not limit the invention. Modifications to those embodiments or other embodiments may fall within the scope of the invention.

What is claimed is:

1. A method of selecting, assembling, and displaying a combination of projects for a user, comprising:
(a) selecting a first project from a collection;
(b) determining if the first project is within a user time-frame via software executing on a computer;
(c) determining if the first project cost is less than a user budget via software executing on a computer;
(d) adding the first project to the combination via software executing on a computer if steps (b) and (c) are true;
(e) subtracting the first project cost from the user-defined budget via software executing on a computer;
(f) selecting a second project from the collection;
(g) determining if the second project is within the user time-frame via software executing on a computer;
(h) determining if the second project cost is less than the user budget via software executing on a computer;
(i) adding the second project to the combination via software executing on a computer if steps (g) and (h) are true; and
(j) displaying information about the combination to the user via software executing on a computer.

2. The method of claim 1, wherein the costs of the projects include man-hours required to complete the projects and the user budget includes available man-hours.

3. The method of claim 2, further comprising:
(k) determining if the first and second projects temporally overlap via software executing on a computer subsequent to step (f);
(l) subtracting the man-hours required for the first project from the available man-hours via software executing on a computer if step (k) is true; and
(m) determining if the man-hours required for the second project is less than the available man-hours via software executing on a computer; and
(n) performing step (i) only if step (m) is true.

4. The method of claim 2, wherein the available man-hours includes a number of full-time and part-time employees available to the user and the required man-hours includes a number of full-time and part-time employees required for the projects; and
wherein steps (c) and (h) include determining if the required full-time and part-time employees is less than the available full-time and part-time employees.

5. The method of claim 4, further comprising:
(k) determining if the first and second projects temporally overlap via software executing on a computer subsequent to step (f);
(l) subtracting the full-time employees and part-time employees required for the first project from the available full-time and part-time employees via software executing on a computer if step (k) is true; and
(m) determining if the full-time and part-time employees required for the second project is less than the available full-time and part-time employees via software executing on a computer; and
(n) performing step (i) only if step (m) is true.

6. The method of claim 1, wherein the project costs include the capital required for the projects, and the user budget includes available capital of the user.

7. The method of claim 1, further comprising:
(k) assigning risk scores to projects in the collection;
(l) determining if the first project risk score is less than a user risk tolerance via software executing on a computer subsequent to step (a);
(m) performing step (d) only if step (l) is true;
(n) determining if the second project risk score is less than a user risk tolerance via software executing on a computer subsequent to step (f); and
(o) performing step (i) only if step (n) is true.

8. The method of claim 7, further comprising:
(p) determining a cumulative risk score for the combination based on the risk scores of he first and second projects via software executing on a computer subsequent to step (i);
(q) displaying the cumulative risk score to the user during step (j).

9. The method of claim 7, wherein the risk scores assigned in step (k) are determined based on the locations and industries of the projects.

10. The method of claim 1, further comprising:
(k) repeating steps (a) through (i) to assemble a second combination of projects; and
(l) displaying information about the second combination to the user via software executing on a computer.

11. The method of claim 10, further comprising:
(m) comparing the combinations of projects via software executing on a computer; and
(n) displaying information generated from the comparison performed in step (m) to a user via software executing on a computer.
